(19) United States
(12) Patent Application Publication
(10) Pub. No.: US 2012/0047811 A1
(43) Pub. Date: Mar. 1, 2012

(54) Garage Door Rodent Guard

(76) Inventor: Rickford J. Weeks, Culpeper, VA (US)

(21) Appl. No.: 13/169,334

(22) Filed: Jun. 27, 2011

Related U.S. Application Data
(60) Provisional application No. 61/378,004, filed on Aug. 30, 2010.

(51) Int. Cl. E06B 7/28

(52) U.S. Cl. 49/460; 49/506

(57) ABSTRACT

An architecture is presented for a guard device that enables a homeowner to effectively prevent unwanted elements, such as rainwater, snow, yard and other debris, rodents and the like from accessing the interior of a garage and that is not easily damaged or compromised by rodents chewing or clawing at the guard. More specifically, the guard of the present invention is intended to be secured to a garage door weather seal to create a barrier in the vicinity of the intersection of the garage floor, garage door and door frame that is substantially impenetrable to chewing or clawing by rodents and that can also be used to repair existing damage to the weather seal.

### CROSS-REFERENCE

This application claims priority from Provisional Patent Application Ser. No. 61/378,004 filed Aug. 30, 2010.

### BACKGROUND

There oftentimes exist a gap between the perimeter of a garage door and the door frame when a garage door is in the closed position. Unfortunately, the gap permits all kinds of unwanted elements to enter the interior of the garage including, without limitation, rainwater, snow, yard and other debris, and rodents and the like. All of the forgoing elements are undesirable and could result in significant damage to the interior of the garage, or an unclean or unhealthy atmosphere within said garage.

Heretofore, one solution to the existing problem of undesirable elements entering into a garage interior has been to utilize a garage door weather seal to fill in the gap between the perimeter of a garage door and the garage door frame. However, said weather seals are typically constructed from a flexible rubber or polyvinyl chloride material, which is vulnerable to chewing and clawing by mice and other rodents seeking to gain access to the interior of the garage, particularly in the general vicinity of the intersection of the floor, garage door and garage door frame. Unfortunately, once the weather seal has been damaged or compromised, the homeowner is presented with all of the above referenced problems associated with the gap that exists between garage doors and their respective frames, and are forced to replace the weather seal which can be time consuming and costs and is, therefore, undesirable. Presently, there is no garage door weather seal option that offers a non-chewable material to prevent mice and other rodents from entering the interior of a garage, or worse, the interior of the home.

Consequently, there exists in the art a long-felt need for a device that enables a homeowner to effectively prevent unwanted elements, such as rainwater, snow, yard and other debris, rodents and the like from accessing the interior of a garage and that is not easily damaged or compromised by rodents chewing or clawing at the device. There also exists a long-felt need for a device that accomplishes the forgoing objectives and that is relatively easy and inexpensive to manufacture and install. Finally, there is a long-felt need for a device that accomplishes all of the forgoing objectives and that can be retrofitted to existing weather seals and garage doors and/or their respective door frames, regardless of whether the same is already damaged.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a guard that enables a homeowner to effectively prevent unwanted elements, such as rainwater, snow, yard and other debris, rodents and the like from accessing the interior of a garage and that is not easily damaged or compromised by rodents chewing or clawing at the device. More specifically, the guard of the present invention is intended to be secured to a garage door weather seal to create a barrier in the vicinity of the intersection of the garage floor, garage door and door frame that is substantially impenetrable to chewing or clawing by rodents and that can also be used to repair existing damage to the weather seal.

In a preferred embodiment of the present invention, the rodent guard is comprised of an elongated strip of relatively thin gauged metal, such as aluminum trim coil, that is folded longitudinally into the general shape of a “V” and that can be attached to prior art weather seal by any common means known in the art including, without limitation, crimping, adhesively, etc. More specifically, the guard is intended to be attached to the weather seal in the general vicinity of the intersection of the garage floor, garage door and the door frame as more fully described below.

In an alternative embodiment, the guard of the present invention can be offered to consumers in the form of a kit that can be comprised of two guards, cleaning wipes, tape or other adhesive material for further securing the guards to the weather seal as the garage door is repeatedly raised and lowered, and an instruction sheet for advising a user on how to properly install the guards on the weather seal. A crimping or other tool may also be included in the kit to assist the user in installing the guard on the weather seal.

Additionally, a method of properly installing the guards of the present invention is also described herein.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a partial perspective view of a prior art weather seal attached to a garage door frame at the intersection of the garage door frame and a garage floor.

FIG. 2 illustrates a perspective view of the guard of the present invention.

FIG. 2A illustrates a perspective view of an alternative embodiment of the guard of the present invention.

FIG. 3 illustrates a partial perspective view of one embodiment of the guard of the present invention installed on a prior art weather seal attached to a garage door frame in the vicinity of the intersection of the garage door frame and the garage floor.

FIG. 3A illustrates a top view of the guard of the present invention installed on a prior art weather seal.

FIG. 4 illustrates a perspective view of a kit comprising two guards, a cleaning wipe, adhesive tape and an instruction sheet.

FIG. 5 illustrates a table illustrating the preferred method of installation of the guard of the present invention.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

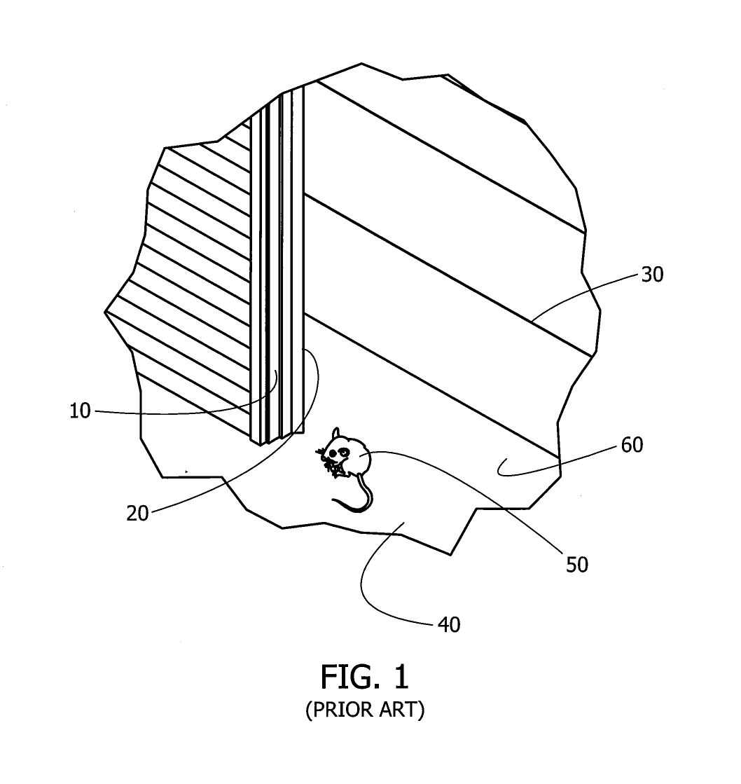

By way of background, FIG. 1 illustrates a partial perspective view of a prior art garage door frame 10, weather seal 20, a garage door 30 in a partially raised position, and a garage floor 40. More specifically, prior art weather seal 20 is typically an elongated strip of flexible rubber or polyvinyl chloride material that is longitudinally attached to prior art garage door frame 10 in a manner that is well known in the art. Weather seal 20 is meant to seal or cover the gap (not shown) that exists between a prior art garage door 30 and its respective garage door frame 10 when garage door 30 is in the closed position, meaning garage door 30 is in contact with prior art floor 40. Unfortunately, as previously stated, weather seal 20 is only a short-term solution to the problems associated with said gap (not shown) because weather seal 20 is susceptible to damage caused by rodents 50 chewing and clawing at weather seal 20 to gain access to the interior 60 of the garage.

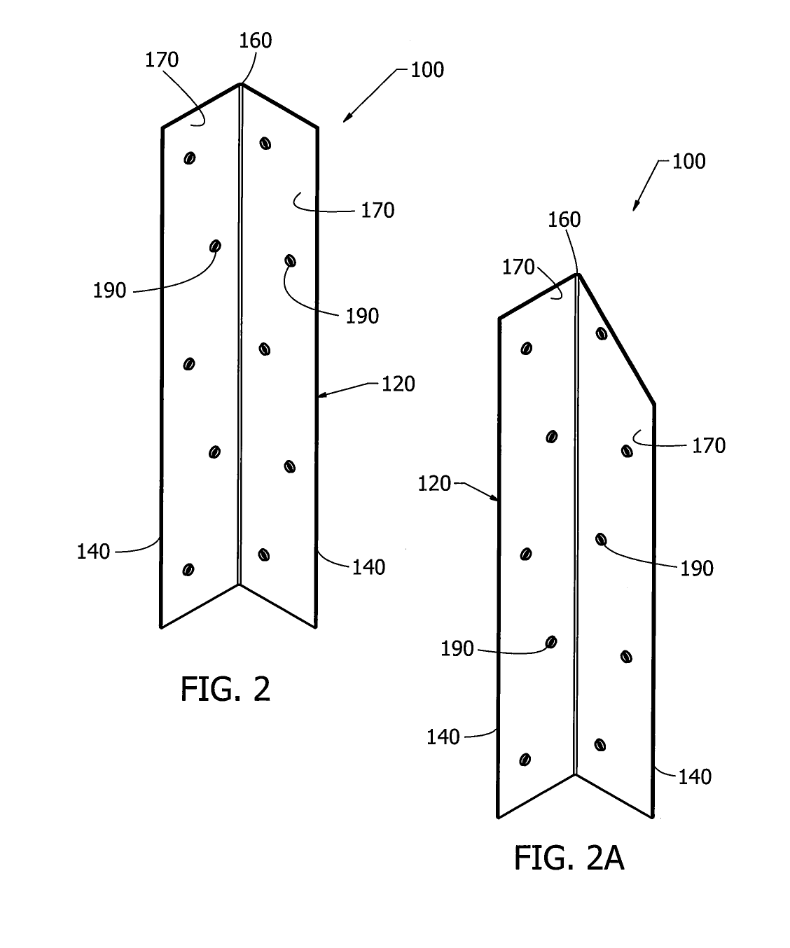

FIG. 2 depicts a perspective view of the guard 100 of the present invention. In the preferred embodiment of the present invention, guard 100 is an elongated generally “V” shaped member 120 comprised of two legs 140 connected to one another by a corner 160. Elongated member 120 further comprises an interior surface 170 and an exterior surface 180. In the preferred embodiment of the present invention, interior surface 170 may further comprise at least one raised surface portion or indentation 190, the purposes of which will be further described in further detail below. Guard 100 is preferably the same color as weather strip 20 and/or door frame 10 to as to blend in and provide for an aesthetically pleasing appearance once installed.

Unless otherwise stated, all components of guard 100 are preferably comprised of a relatively light-weight and thin gauged metal such as aluminum trim coil. Nonetheless, it is contemplated that other materials could also be used, such as tin, copper, iron, zinc and the like, provided that said materials are not susceptible to damage caused by chewing and/or clawing of rodents 50.

Elongated member 120 is preferably between 2 and 14 inches in length, although it is contemplated that elongated member 120 could be longer or shorter to suit user preference, provided that elongated member 120 is of sufficient length to deter or prevent chewing or clawing of weather seal 20 by rodent 50.

Each of legs 140 are preferably ½ to 1¼ inches in width, as measured from corner 160 to the edge of leg 140, though it is contemplated that the width of each of legs 140 could vary to suit user preference, provided that the width of leg 140 is sufficient to substantially cover weather seal 20 when properly installed as further described below. It is also contemplated that at least one end of legs 140 could be cut at an angle, as best depicted in FIG. 2A, to allow for smooth passage of garage door 30 past guard 100 when installed on weather seal 20, as will be further described below.

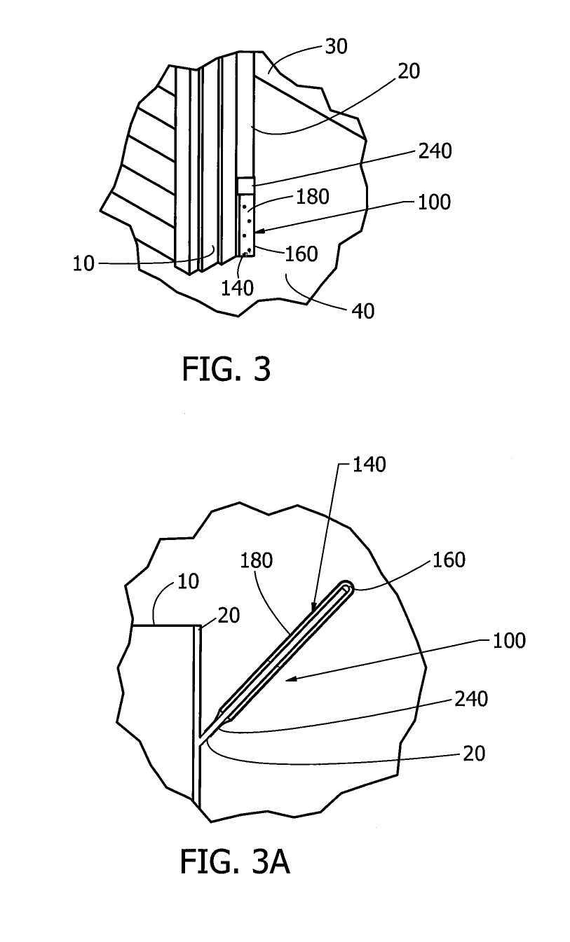

FIG. 3 depicts a partial perspective view of one embodiment of the guard 100 of the present invention installed on a prior art weather seal 20 which is, in turn, attached to prior art garage door frame 10 in the general location of the intersection of garage door frame 10 and prior art garage floor 40. When properly installed, guard 100 is used to prevent or reduce the likelihood of rodents 50 accessing garage interior 60 by chewing or clawing their way through the previously exposed weather seal 20. The proper installation of guard 100 is further described below. FIG. 3A depicts a top view of guard 100 properly installed on prior art weather seal 20.

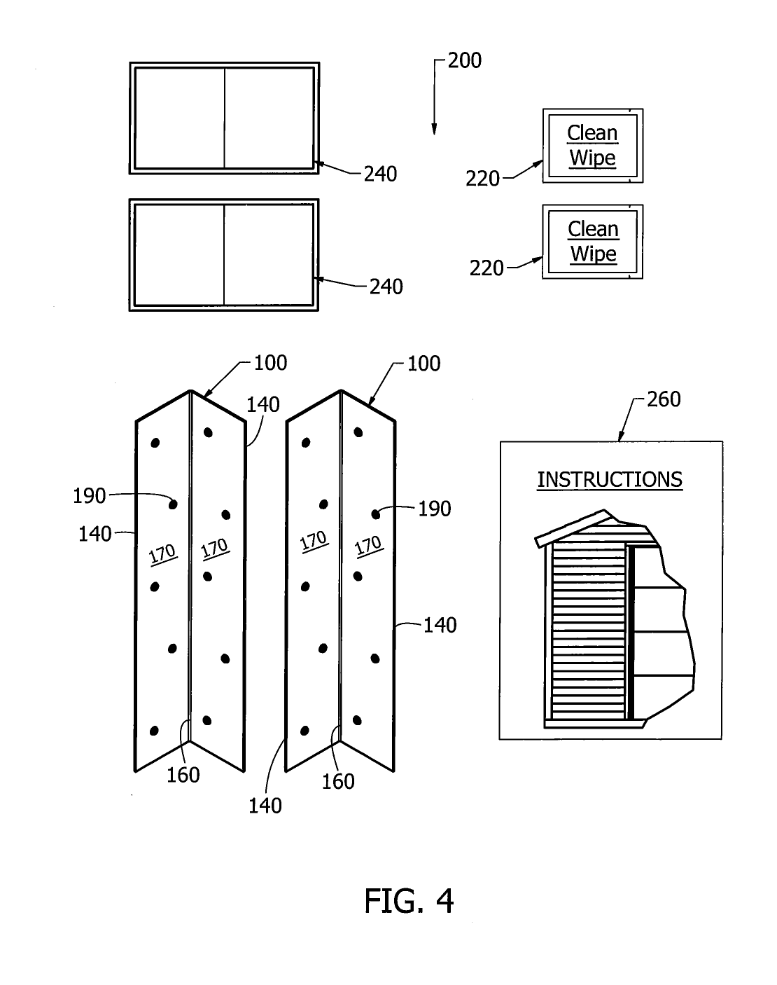

It is also contemplated that guard 100 could be presented to consumers and/or users as part of a kit 200. More specifically, FIG. 4 depicts a kit 200 comprised of two guards 100, a wipe 220, tape 240 and an instruction sheet 260, the purpose of each of which will be described further below. More specifically, kit 200 includes at least two guards 100 so that a guard 100 can be installed on the weather seal 20 on each side of the garage door frame 10. Nonetheless, it is also contemplated that kit 200 could be further comprised of additional or replacement guards 100 and/or other tools (not shown), such as a crimping tool or pliers and the like, to make installation of guard 100 even easier on the user as described below.

Cleaning wipe 220 can be any prior art cleaning wipe or towelette known in the art and that is used for cleaning a surface so that paint and/or tape can thereafter be securely applied thereto. Wipes 220 are believed to be readily available at most department stores and other places that commonly sell cleaning supplies. Similarly, adhesive tape 240 can be any durable prior art tape that is known in the art, and is also known to be readily available in most department and convenient stores. Tape 240, the purpose of which will be described further below, is preferably the same color as guard 100 and/or weather seal 20 to provide for an aesthetically pleasing appearance once properly installed.

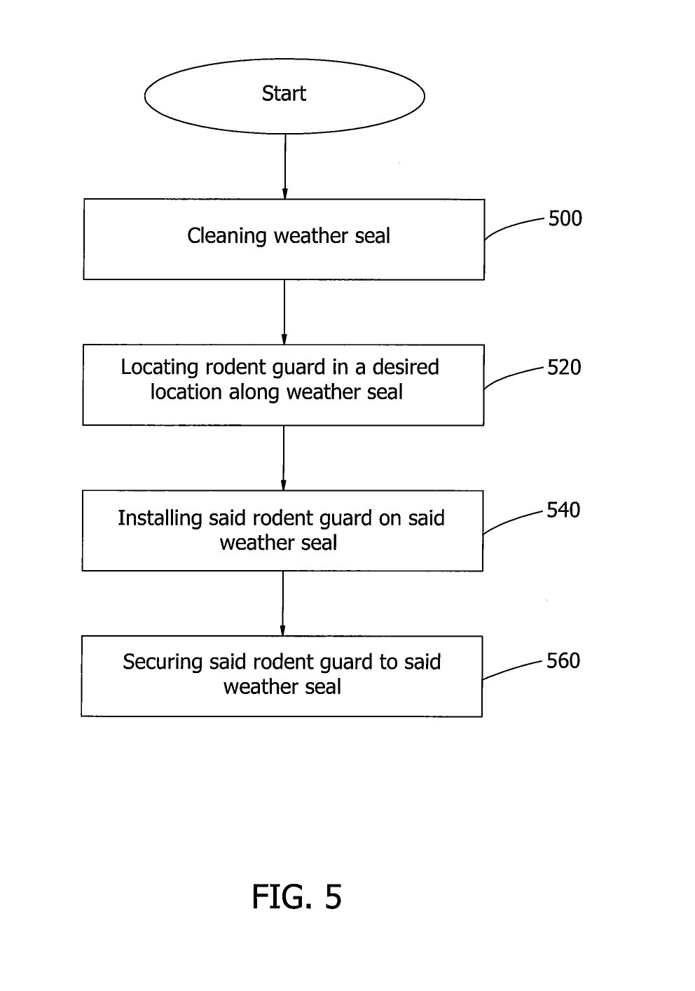

Now that the individual components of guard 100 and kit 200 have been described, the method of installing guard 100 on prior art weather seal 20 will now be described. The process of installing guard 100 on weather seal 20 is also depicted in FIG. 5, and a properly installed guard 100 is depicted in FIGS. 3 and 3A.

While, for purposes of simplicity of explanation, the one or more methodologies shown herein (e.g., in the form of a flow chart or flow diagram) are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Prior to installing guard 100 onto weather seal 20, it is preferred that user (not shown) prepare weather seal 20 and garage door frame 10 by cleaning 500 the surfaces thereof with, for example, wipe 220 to insure a secure connection between guard 100 and weather seal 20. More specifically, any existing dirt, grime, grease and/or loose paint should be removed from the portion of weather seal 20 and garage door frame 10 where guard 100 and tape 240 will be applied.

Once weather seal 20 has been properly cleaned 500, user will position or locate 520 guard 100 along weather seal 20 in the general vicinity of where door frame 10 and weather seal 20 intersect with garage floor 40, although it is contemplated that guard 100 can be installed anywhere along weather seal 20 that user desires. For example, a user may desire to locate multiple guards 100 along the entire length of weather seal 20, or only at desired locations.

Once weather seal 20 has been properly cleaned 500 and an appropriate location along weather seal 20 selected, user will install 540 guard 100 on weather seal 20 by placing it over weather seal 20 such that weather seal 20 is in contact with at least a portion of the interior surface 170 of elongated member 120. At such time, user may apply pressure to the exterior surface 180 of elongated member 120, thereby pushing each of legs 140 generally towards weather seal 20 and in the direction of each other. As the interior surface 170 of elongated member 120 is brought into further contact with weather seal 20, raised surface portions 190 on interior surface 170 will become imbedded or lodged in weather seal 20, thereby further attaching guard 100 to weather seal 20. In a preferred method of installation, user may also use a crimping tool (not shown), such as pliers, vice-grips or the like, to further clamp guard 100 onto weather seal 20. As previously mentioned, at least one of legs 140 may be cut at an angle as depicted in FIG. 2A to ensure smooth passage of garage door 30 past guard 100 (i.e., to prevent garage door 30 from catching on or damaging guard 100 when being closed). Properly installed guards 100 are depicted in FIGS. 3 and 3A.

Once guard 100 has been properly installed 540 on weather seal 20, tape 240 can be used to further secure 560 guard 100 to weather seal 20. More specifically, adhesive tape 240 is preferably installed by placing tape 240 adjacent to door frame 10 and over both a portion of one leg 140 and a portion of adjacent weather seal 20 thereby covering up or concealing the seam created by guard 100 and weather seal 20 and allowing for a smoother transition between the end of the guard 100 and weather seal 20. Tape 240 is then folded over exterior surface 180 to the edge of the opposite leg 140 and the corresponding portion of weather seal 20. In a preferred embodiment, tape 240 is approximately 2 inches long and covers approximately 1 inch of guard 100 and 1 inch of the adjacent weather seal 20. Tape 240 is preferably approximately 3 inches in width and preferably extends from the edge of one leg 140, around corner 160 and to the edge of the opposite leg 140. Tape 240 may also overlap a portion of door frame 10 or cut to user preference.

Importantly, guard 100 can be installed on new or damaged weather seal 20, thereby permitting users to repair damaged weather seal 20 without having to replace the same, which can be costly and time-consuming and, therefore, undesirable.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rodent guard comprising:
an elongated member, wherein said elongated member further comprises
two legs;
a corner;
an exterior surface; and
an interior surface.

2. The rodent guard of claim 1, wherein said rodent guard is substantially comprised of metal.

3. The rodent guard of claim 1, wherein a cross section of said rodent guard is substantially V-shaped.

4. The rodent guard of claim 1, wherein said interior surface further comprises at least one raised surface portion.

5. The rodent guard of claim 4, wherein said at least one raised surface portion is in contact with a weather seal when said rodent guard is properly installed on a weather seal.

6. The rodent guard of claim 1, wherein said rodent guard is attached to a weather seal.

7. The rodent guard of claim 6, wherein said weather seal is attached to a door frame.

8. A kit for preventing rodents from damaging weather seal comprising:
a rodent guard;
a wipe; and
a tape.

9. The kit of claim 8, wherein said kit further comprises a crimping tool.

10. The kit of claim 8, wherein said rodent guard is further comprised of
an elongated member, wherein said elongated member further comprises
two legs;
a corner;
an exterior surface; and
an interior surface.

11. The kit of claim 8, wherein said rodent guard is substantially comprised of metal.

12. The kit of claim 10, wherein said interior portion is further comprised of at least one raised surface portion.

13. The kit of claim 8, wherein said rodent guard is attached to a weather seal.

14. A method for protecting a weather seal comprising:
cleaning the weather seal;
locating a rodent guard in a desired location along said weather seal; and
installing said rodent guard in said desired location.

15. The method of claim 14 further comprised of the step of securing said rodent guard to said weather seal.

16. The method of claim 14, wherein said rodent guard is comprised of:
an elongated member, wherein said elongated member further comprises
two legs;
a corner;
an exterior surface; and
an interior surface.

17. The method of claim 14 wherein said rodent guard is substantially comprised of metal.

18. The method of claim 16 wherein said interior portion further comprises at least one raised surface portion.

19. The method of claim 14 wherein a crimping tool is utilized to accomplish the installing said rodent guard in said desired location.

20. The method of claim 15 wherein tape is utilized to accomplish the securing said rodent guard to said weather seal.
